(19) United States
(12) Patent Application Publication
(10) Pub. No.: US 2015/0367532 A1
(43) Pub. Date: Dec. 24, 2015

(54) SINGLE-SCREW PLASTIFICATION MACHINE AND METHOD FOR PLASTIFICATION OF A STARTING MATERIAL

(71) Applicant: Reifenhaeuser GmbH & Co. KG Maschinenfabrik, Troisdorf (DE)

(72) Inventor: Tim Carsten POHL, Koeln (DE)

(73) Assignee: Reifenhaeuser GmbH & Co. KG Maschinenfabrik, Troisdorf (DE)

(21) Appl. No.: 14/767,954

(22) PCT Filed: Feb. 16, 2014
(86) PCT No.: PCT/DE2014/000057

§ 371 Date: Aug. 14, 2015

(30) Foreign Application Priority Data
Feb. 15, 2013 (DE) 10 2013 002 559.1

(51) Int. Cl. B29B 7/42; B29C 47/00

(52) U.S. Cl. CPC B29B 7/42; B29C 47/0023; B29L 2023/22

(57) ABSTRACT

For almost 100 years, extruders have been built in such a manner that at a predetermined screw diameter, a corresponding throughput capacity is achieved, depending on the process conditions.

To increase the output capacity, the screw diameter is generally increased in accordance with the physical laws of similitude. The length-to-diameter ratio remains the same, or the extruder becomes longer. This leads to the result that an engineer strives to use an extruder having a small screw diameter.

In order to avoid the disadvantage of space-intensive extruders, fast-turning single-screw extruders have been developed in the past 10 years. Extruders having a screw diameter of 35 mm to 100 mm and having a length of 30 D to 40 D are usual in practice.

Ultimately, however, all concepts usual on the market fail to implement a universal extruder.

The invention is based on the task of presenting a universal concept of a single-screw plastification machine. The invention discloses a squat screw having a diameter of at least 200 mm and having an active length L that has a ratio L/D to the screw diameter D of 1 to 8.

The invention relates to a single-screw plastification machine for conveying, melting, homogenizing and building up pressure in—in other words plasticizing—a starting material, as well as to a method for conveying, melting, homogenizing and building up pressure in—in other words plasticizing—a starting material.

The “starting material” particularly comprises plastics, above all thermoplastic polymers, if applicable with powder-form and fiber-form additives, as well as food masses.

The “single-screw plastification machine” can be, above all, an extruder, so that the invention above all relates to a single-screw extruder for thermoplastic polymers, as well as to a method for plastification of thermoplastic polymers, using such an extruder.

Single-screw plastification machines are comprehensively known in the state of the art. A detailed explanation of their structure and of the flow calculation is found in Schbppner, Volker, “Verfahrenstechnische Auslegung von Extrusionsanlagen [Process-technology design of extrusion systems]” in the publication series “Fortschritts-Berichte VDI [Progress reports of the VDI [Verein deutscher Ingenieure=Association of German Engineers]], Series 3, No. 715, Dusseldorf, VDI Verlag [VDI Publishing Company] 2001, ISBN 3-18-371503-1, in Chapter 4.2.

A concrete proposal for a single-screw plastification machine can be derived from DE 102 17 686 A1.

Single-screw plastification machines are frequently found in the form of extruders or in plastics injection-molding machines, for example. Within the extruders, those that are or can be part of a system for the production of profiles, tubes, films, blow-molded parts, panels, filaments, nonwoven fabrics, ribbons, semi-finished products, hoses, cables, granulate, compound or foam semi-finished products shall be particularly considered here.

Numerous demands are made on a plastification machine: for example, for good construability, it should be possible to maintain the most constant conveying rate possible even at different counter-pressures. Furthermore, it is supposed to achieve good homogeneity of the starting material to be processed, at an optimal predetermined extrusion temperature. Furthermore, it is supposed to be able to process the broadest material spectrum possible, but at the same time have low, efficient energy consumption, and thereby be sparing of resources, in total. And, in addition to the usual demands for the best possible price/performance ratio, a low space requirement, low noise development, great availability, wear resistance and ease of maintenance, it is supposed to be capable of scale-up. The latter is interesting, above all, for the manufacturer of an extruder, in order to be able to offer reliable extruders for the most varied throughputs and plastics.

Since the time of industrialization, extruders have been built in such a manner that a corresponding throughput capacity or a throughput range is achieved at a predetermined screw diameter, depending on the process conditions, in other words depending on the pressure, type of polymer used, molding mass temperature, homogeneity, etc.

If the throughput capacity is supposed to be increased, while the other process conditions are maintained, the screw diameter is generally increased, in accordance with the physical laws of similitude. The length-to-diameter ratio, which is usually referred to as L/D in technology, remains the same, or the extruder becomes longer due to melting problems and dwell-time problems. This leads to the result that an engineer strives to use an extruder having the smallest possible screw diameter.

To increase the output capacity \dot{m}, fundamentally the free channel volume must be increased and the dwell time must be adapted accordingly, in order to melt the material completely. However, the screw channel volume cannot be increased simply as desired, because the screw must still transfer the required drive torque. Ultimately, the screw diameter therefore must become greater.

In order to avoid the disadvantage of space-intensive extruders, fast-turning single-screw extruders have been developed in the past ten years. Extruders having a diameter D of 35 mm to 100 mm and having a cylinder length L of 30 D to 40 D, as well as having a circumferential speed of more than 1 m/s have become usual in practice.

It is a disadvantage that the material is severely sheared as a result of the high circumferential speeds, that the melting temperature is high, due to the process conditions, and that the processing window is small.

Ultimately, however, all the concepts usual on the market have difficulty in making a universal extruder available that is actually independent of the screw diameter and can be freely scaled using the laws of similitude. There are several reasons for this: First of all, the conveying capacity is dependent on the friction values between polymer and steel as well as within the polymer, thereby making it dependent on the channel depth, the channel width and the polymer properties, in other words there is no actual physical similitude, because the sliding behavior and adhesion behavior cannot be depicted according to the theory of similitude. Also, the melting capacity does not behave precisely proportional to the dwell time and the shear energy. Finally, different polymers are not physically similar with regard to viscosity, melt enthalpy, friction values and morphology.

For this reason, extruders are optimally adapted to the respective statement of task nowadays, in an individualized manner, with empirical knowledge and process technology know-how. In concrete terms, a person skilled in the art begins the design process for an extruder, for general conditions to be achieved, in that he/she uses a small, proven extruder as the starting geometry, applies the physical laws of similitude beginning with this starting geometry, and then improves the work capacity of the extruder in subsequent iterative refinement steps. In this connection, it cannot be guaranteed that the extruder designed in this manner will achieve the quality of results of the proven extruder having the starting geometry.

In practice, extruders in the parameter ranges

| | |
|---|---|
| circumferential speed | 0.05 to 1.5 m/s, |
| | fast-running > 1.0 m/s, |
| L/D | 16 to 36 (partly up to 40), |
| h/D | 1/5 to 1/20, |
| number of threads i | 1 to 2, and |
| diameter D | 18 to 250 (partly up to350) |

have become known.

In Gerhard Schenkel: Kunststoff-Extrudertechnik [Plastics extruder technology], 2^{nd} edition of the book “Schneckenpressen für Kunststoffe [Screw presses for plastics],” Carl Hanser Verlag [publisher], Munich, 1963, various calculations for an understanding of the mechanical model laws are presented on pages 167-169, wherein the L/D ratio of the extruders similarly calculated as models for other values in this connection is indicated as being about 3.2 at a diameter D of 150 mm in one example. On page 169, it is mentioned that in such calculations, one arrives at “significantly shorter screws,” but that this theoretical “proposal cannot be viewed as an implementable solution of the problem.”

Experience has seen this the same way: Since the 1970s, above all in view of the introduction of grooved-barrel extruders and fast-turning single-screw extruders, corresponding geometries have been classified as not being efficient. The low throughput in relation to the high back-pressure due to the great screw diameter has been interpreted as being disadvantageous. For a good 40 years, in the meantime, experts have been striving to obtain a high output capacity from extruders that are as small and long as possible, in other words that have a high L/D ratio. In practice, since the 1970s the screw length has actually developed from about 20 L/D in the direction of up to 40 L/D for fast-turning screws (screws that run at a circumferential speed of >1 m/s are referred to as fast-turning screws).

In the sector of hot-rubber extruders or, in general, natural rubber extruders, there can be very short extruders having a large diameter, as mentioned, for example, in Lothar Koster: Praxis der Kautschukextrusion [Practice of natural rubber extrusion], Carl Hanser Verlag, Munich, ISBN 978-3-446-40772-5, table on page 5; also confirmed by James White, Helmut Potente: Screw Extrusion, Hanser Verlag, ISBN 3-446-19624-2. There, it is explained that natural rubber extruders are structured to be clearly shorter, in terms of design, and that tempering takes place with water instead of electrically or with oil tempering in the case of plastics extruders. If the natural rubber is passed to the extruder in pre-heated form (application temperature=60-90° C.), then the hot-fed extruder is reduced from 14-20 L/D to 6-12 L/D.

However, the extruders for natural rubber or hot natural rubber have nothing to do with the species that is the object of the invention, because in the extruders for natural rubber or hot natural rubber, the matter of concern is not to melt or plasticize a starting material. This is because a natural rubber or hot natural rubber already has the required properties originally. As a result, a natural rubber is filled into the extruder at room temperature, for example, and generally leaves the extruder at between 90° C. and 130° C. If an overly high temperature is reached, the natural rubber is quickly damaged. The processing temperature is less than 130° C. Furthermore, natural rubber does not experience a phase conversion from solid to liquid during processing. Also, natural rubber is generally fed to an extruder in strip form, so no compacting is required, either, as it is when adding a granulate of thermoplastic polymers. Instead, the natural rubber extruder has the primary task of continuously conveying, heating the natural rubber uniformly, and building up an extrusion pressure.

Thermoplastic plastics, in contrast, are processed at 170° C. to 350° C. As described in the preamble of the present claims, they are additionally compacted and melted in the extruder—in other words a phase conversion from solid to liquid necessarily takes place.

The invention is based on the task of making an improvement or alternative available to the state of the art.

According to a first aspect of the present invention here, this task is accomplished by a single-screw plastification machine for conveying, melting and homogenizing plastic, wherein the single-screw plastification machine has a screw having a screw diameter and an active length, and wherein the single-screw plastification machine is set up for rotating the screw, during operation, by means of a controller, at a circumferential speed, wherein two or all three of the following parameter ranges are adhered to, namely that:
the screw diameter D amounts to at least 150 mm, particularly 200 mm to 800 mm,
the active length L has a ratio L/D to the screw diameter D of 1 to 8, and/or
the controller is set up for operating the screw at a circumferential speed of less than 1.5 m/s, preferably of less than 1.0 m/s, particularly preferably of between 0.05 m/s and 1.0 m/s.
   Within the indicated parameter ranges, the following intermediate values are understood to be disclosed in concrete terms, so that the above interval limits can be optionally restricted by the following:
The screw diameter D should amount to at least 150, 200, 300, 400, 500, 600, 700 or 800 mm, as an ancillary measure, and/or
the screw diameter D should amount to at most 500, 600, 700, 800 mm or more, as an ancillary measure, and/or
the ratio L/D should amount to at most 8, 7, 6, 5, 4, 3 or 2, as an ancillary measure, and/or
the ratio L/D should amount to at least 1, 2, 3, 4, 5, 6 or 7, as an ancillary measure, and/or
the circumferential speed should amount to at most 1.0, 0.9, 0.8, 0.7, 0.6 or 0.5 m/s, as an ancillary measure, and/or
the circumferential speed should amount to at least 0.001, 0.05, 0.1, 0.2, 0.3, 0.4 or 0.5 m/s, as an ancillary measure.

The following should be explained with regard to terminology:

The single-screw plastification machine is “set up” for melting and homogenizing the starting material that is relevant here, in other words a thermoplastic plastic, if it is set up, in any case, for achieving a temperature range required for this purpose. This range begins at approximately 150° C. or 160° C., even actually at approximately 170° C. The machine must therefore be set up for conveying, melting and homogenizing the plastic at 160° C., 170° C. or more. For this purpose, it can have an active heating means, for example, which is directed at the plastics stream in the course of the active length L of the screw, above all an electrical heating unit and/or a water heating unit and/or another type of fluid heating unit, such as, above all, an oil heating unit.

Preferably, a shut-off means is provided, which signals an alarm or actually shuts the producing machine off automatically, if a temperature is not reached on or in the active length L or even just set, which temperature lies in the range of above 100° C., for example of above 130° C. or above 140° C., but above all at about 150° C., preferably, however, below 170° C.

The diameter that is usually used when calculating the design is referred to as the “screw diameter” D. This is the inside diameter of the cylinder that encloses the screw.

The variable that is usually referred to as the variable L in calculation and design is referred to as the “active length” L. The variable L refers to the active screw length. This runs, in a normal case, from the front edge of the funnel all the way to the beginning of the screw tip, in other words all the way to the transition from the screw geometry to the tip.

The cylinder is either smooth on the inside over the length L, smooth being understood to mean a surface roughness of maximally 0.1 mm within the scope of the present disclosure here; or there is a smooth section and a rough section within the length L, for example with a rough inner surface in the intake region of the extruder, to improve conveying of solid material. A rough surface can have scoring, grooves, spirals or another macroscopic profiling, for example, above all as known from the state of the art and/or regularly disposed.

The “controller” is supposed to comprise all types of controllers, with a regulation unit being understood to be a subset. When a controller is mentioned within the scope of the present patent application here, this should therefore be understood as a “controller, particularly regulation unit.” In particular, the speed of rotation, the temperature, the pressure/speed of rotation behavior, and the speed of rotation/throughput behavior are possible regulation technology parameters.

It is decisive for the implementation of the invention that the single-screw plastification machine allows a working point, by means of its controller, which point lies within the value limits claimed here. This can easily be fulfilled even if the controller is additionally designed for operating the single-screw plastification machine also with an alternative working point, which lies outside of the value limits claimed here.

The “circumferential speed” is the tangential speed of any desired point on the outermost diameter of the screw in the operating angular speed of the screw. The circumferential speed therefore corresponds to the product of the angular speed of the screw during operation and the screw diameter D, wherein it is assumed, for the calculation, that the remaining gap width between the outermost circumference of the screw and the inside diameter of the cylinder is zero.

A screw of the form proposed here has a surprisingly short active length L, but in turn a surprisingly large screw diameter D. Not only is a significant reduction of the required construction space achieved in this way, but above all very great freedom in the adaptation of the screw geometry to the respective process technology tasks is gained. To change the desired throughput, the length can simply be changed at a constant diameter when designing the extruder. At the same time, this is a significant deviation from the idea of Gerhard Schenkel, who speaks of increasing the diameter while keeping the length the same. The great advantage of the present invention here is, in contrast, to keep the diameter great and to change the length. In this way, it is possible to adapt the extruder output by means of a comparatively slight change in the screw length, without changing the melt properties.

It is proposed that the single-screw plastification machine has a melt pump in the machine direction, beyond the active length of the screw, which pump is set up for producing a pressure buildup during operation.

Melt pumps as such are known on the market for extruders of the type relevant here. For example, the extruder screw can convey the melt directly into a melt pump chamber, which is affixed to the front of the screw tip, as a continuation of the cylinder. There, two axis-parallel rolls that mesh with one another are situated, the axes of which rolls lie at a right angle to the extrusion direction, in other words the machine direction. They can be operated with an adjustable direction of rotation and with an adjustable speed of rotation, so that they set the melt counter-pressure at the screw tip, and thereby offer a further possibility for influencing the pressure and flow profile in the extruder. In a usual case, a melt pump is used to reduce the screw counter-pressure or to take on part of the pressure buildup. Often, pressure sensors are situated both in front of and behind the pair of rolls.

A melt pump appears practical, according to the present level of knowledge, above all starting from about 200 bar extrusion resistance.

In the case of an extruder that is used as part of a system for the production of spunbonded nonwoven fabric, the use of a melt pump already appears practical starting from about 100 to 150 bar extrusion resistance.

A further advantage lies in that a melt pump represents an advantageous variant, in terms of design, in order to change from a relatively large screw diameter to a relatively smaller connection cross-section for further transport of the melt on the other side of the melt pump.

Often, there is a screen ahead of and/or behind the melt pump. A screen that is situated ahead of the melt pump often serves to protect the melt pump and can be structured as a relatively coarse screen. Often, a screen changer is situated ahead of and behind the melt pump.

The disadvantage of the over-proportionally increasing axial pressure is counteracted, in terms of design, by the use of a melt pump in combination with a slow-running, short extruder having a comparatively great screw diameter—as proposed above as a single-screw plastification machine. By means of the degree of freedom gained, the melt return flow proportion can furthermore be changed, by means of an adaptation of the screw pre-compression, and the material homogeneity can be adapted to the requirements.

For the sake of completeness, it should be emphasized that the single-screw plastification machine does not necessarily require a melt pump in order to build up the desired pressure. Instead, an extruder without a melt pump can also build up the desired pressure, for example.

In this way, a melt pump at the screw tip is added to the advantage of a space-saving short extruder having a large screw diameter, so that the extrusion pressure can be set to the desired level. This can take place in infinitely adjustable manner or in steps, for example. By means of regulation of the extrusion pressure, the extruder user is given an additional degree of freedom to change the melt temperature or the material homogeneity.

According to a second aspect of the present invention, the set task is accomplished by a single-screw plastification machine, suitable and set up for conveying, melting and homogenizing a starting material, wherein the single-screw plastification machine has a screw having a screw diameter and an active length, and wherein the single-screw plastification machine is set up for rotating the screw, during operation, by means of a controller, at a circumferential speed, particularly a single-screw plastification machine as described above, wherein the machine is characterized in that a pressure reducer is provided in the region of the active length L of the screw and/or in the region of a screw tip beyond the active length L, through which pressure reducer the screw extends with a part of its axial length into a region that is reduced in pressure during operation, particularly into a region having ambient pressure during operation.

The active surface area of the axial pressure on the screw can be reduced by means of a reduction in the size of the active surface area. This reduction in surface area can take place by means of a change in diameter of the screw and/or a change in the inflow cross-section of the region that follows the plastification machine.

For example, it is conceivable as a design embodiment of the region, as an alternative to a melt pump, that an extrusion tool is set onto the end of the screw cylinder, so that an extrudate is formed subsequent to the screw channel.

An extrusion tool can have an annular gap nozzle, for example set up for production of a ring-shaped extrudate such as, above all, a tube, or a granulation head can be provided there, for example.

If the screw projects through a pressure reducer, then the active length L of the screw is now only situated in the region between the filling funnel and the pressure reducer. In this case, the active length L of the screw is shorter than the region of the screw geometry.

It is proposed that an annular gap of the annular gap nozzle lies in alignment with a channel between the screw and the cylinder. In the case of such an embodiment, a transition component between the melt on its path along the screw and its path through the tool, which is otherwise necessary, is eliminated in the case of a suitable construction.

If an extrusion tool is provided at the end of the screw cylinder, then it is proposed that this tool already starts upstream from the screw tip, ideally directly at a screw cylinder that ends upstream from the screw tip, so that the screw tip and/or a part of the screw ahead of the screw tip and/or a counter-bearing that carries the screw at its face side of the screw tip project into the tool or actually project into or through a nozzle of the tool. The screw then lies in the ambient pressure range, in part, if designed accordingly.

According to a third aspect of the present invention here, the set task is accomplished by a single-screw plastification machine, suitable and set up for conveying, melting and homogenizing a starting material, wherein the single-screw plastification machine has a screw having a screw diameter and an active length, and wherein the single-screw plastification machine is set up for rotating the screw, during operation, by means of a controller, at a circumferential speed, particularly a single-screw plastification machine as described above, wherein the machine is characterized in that an extrusion tool is connected beyond the cylinder of the screw, in the machine direction, wherein the extrusion tool, during operation, is set up for producing a granulate, and has a perforated disk for producing a strand as well as a blade for cutting the strand up, wherein the blade is disposed on the screw so as to rotate with it, particularly at the screw tip.

Such an embodiment can be produced very cost-advantageously and in spatially compact manner. Furthermore, the granulate grains are always cut essentially to the same size, independent of the speed of rotation of the screw, because with an increasing speed of rotation, not only does the conveyed mass throughput increase, but the speed of the blade in its circular path also increases.

In a preferred embodiment, the controller is set up for operating the screw at a circumferential speed of less than 1.5 m/s, particularly at a circumferential speed of at most 1.0 m/s, 0.9 m/s, 0.8 m/s, 0.7 m/s, 0.6 m/s or 0.5 m/s. Such an embodiment turns away from fast-running screws and achieves a low extrusion temperature by means of a low circumferential speed.

With regard to the active length L, it is proposed that this length assumes an amount between 300 mm and 2,400 mm. The two limits should be understood as being contained within the interval, in each instance. Furthermore, the limits should be understood not to be sharp limits, in a preferred embodiment, but rather approximate limits. The inventor has also carried out successful calculations and prototype experiments with an active length L of up to less than 300 mm. Also with regard to the upper interval limit, it has not been shown by the previous experiments that the interval according to the invention should necessarily end suddenly there.

For the remainder, the same holds true analogously with regard to the interval limits also with regard to the indicated screw diameter D with its interval limits, and also analogously for the interval limits of the ratio L/D.

As an ancillary measure, 400 mm, 500 mm, 600 mm, 700 mm, 800 mm, 900 mm, 1,000 mm, 1,100 mm, 1,200 mm, 1,300 mm, 1,400 mm, 1,500 mm, 1,600 mm, 1,700 mm, 1,800 mm, 1,900 mm, 2,000 mm, 2,100 mm, 2,200 mm, and 2,300 mm should also be understood to be disclosed as a lower limit and/or as an upper limit of the value interval of the active length L, also preferably as approximate limits in each instance.

With regard to the ratio between the screw diameter D and the channel depth h of the screw channel, a ratio D/h of 20 to 150 is proposed, wherein here, too, the two interval limits do not have to be understood as sharp ends of the practical interval according to the invention, but merely as possible retreat positions within the scope of patentability.

As a term, the channel depth h should be understood to be the radial distance between the screw root and the inside diameter of the cylinder enclosing the screw, so that the inside diameter of the cylinder (in other words the “screw diameter D”) is composed of the diameter of the screw from screw root to screw root and twice the channel depth h, as a sum.

The large ratio D/h also contributes, once again, to a screw that is dimensioned to be very large in terms of screw diameter and, in return, correspondingly short, in other words to a screw having a rather squat shape.

It is proposed that the screw has multiple threads. It can have two screw threads or more than two screw threads, particularly three, four, five, six, seven or eight screw threads, for example. With regard to the number of threads, it should be taken into consideration that a thread divided in two at a barrier zone should be interpreted as precisely one thread.

At this point, it should be explicitly pointed out that within the scope of the present patent application here, each indication with an indefinite numerical article, in other words, for example, “one,” “two,” etc., should be understood to be an “at least” indication, unless it is evident from the respective context that there, only a “precisely” term should be understood, in other words “precisely one,” “precisely two,” etc.

The thread pitch t is found as the distance between two adjacent screw walls of the same channel, in a longitudinal section along the screw.

Preferably, the screw has a modular connection device. Then, different screw lengths can be kept on hand and offered with particularly easy measures.

Maintenance of the screw is greatly facilitated if a cylinder that encloses the screw has a segmented structure. Any cylinder that is not formed from a one-piece hollow cylinder should be understood to be “segmented.” Above all, it should be thought that the cylinder has two or more than two segments, so that the cylinder is axially segmented, in other words is composed of multiple cylinder parts along its length.

The screw can have a temperature-regulating means. The screw can then be temperature-regulated from the inside out, for example by way of a cooling fluid guide or by way of a heating fluid guide. In the case of a temperature-regulated screw, a temperature sensor is preferably additionally present, in order to help detect the thermal feed-back of the material to be plasticized to the surface of the screw.

A preferred embodiment of the screw has a screw shaft having a recess, which has a thrust bearing or is set up for accommodating a thrust bearing.

The screw can have a screw shaft that is structured as a screw mandrel.

It has already been mentioned that the machine is preferably a single-screw extruder.

Extruders are used in numerous sectors of the plastics-processing industry. In particular, an extruder should be thought of which conveys, melts and homogenizes thermoplastic plastics, in order to subsequently pass the plastic melt to a shape-giving nozzle for forming a continuous product. The products are, for example, profiles, tubes, films, blow-molded parts, panels, filaments, nonwoven fabrics, ribbons, semi-finished products, hoses, cables, granulate, compound or foam semi-finished products.

Alternatively, it is easy to imagine that the machine is a plastics injection-molding machine, for example, particularly having a central injection piston. In a plastics injection-molding machine, the plastification screw is generally mounted so as to be longitudinally displaceable. With an increasing amount of conveyed plastic granulate, the latter is collected at the end of the screw, in the plasticized state, until the required amount for injection into the injection-molding cavity has been accumulated. To collect the plastic melt ahead of the screw tip, the screw moves axially backward during plastification. This increases the required construction length beyond the screw length as such.

It is easily evident that such a machine also benefits greatly from a screw having a geometry that is rather squat in shape, particularly having a short construction length.

According to a fourth aspect of the present invention, the set task is accomplished by a single-screw plastification machine for conveying, melting and homogenizing plastics, wherein the single-screw plastification machine has a screw having a screw diameter and an active length, and wherein the single-screw plastification machine is set up for rotating the screw, during operation, by means of a controller, at a circumferential speed, so that during operation, taking into consideration a number of screw threads, a throughput mass stream \dot{m} of the plastic occurs, wherein the active length L amounts to from 200 mm to 2,000 mm, and wherein during operation, the ratio between the mass stream \dot{m} and the active length L amounts to between 0.25 kg/(h*mm) and 1.4 kg/(h*mm), particularly at least 0.4 kg/(h*mm).

It should be explicitly emphasized that a single-screw plastification machine structured in this way can additionally be characterized by all the characteristics described above.

Furthermore, it should be explicitly emphasized that the indicated interval limits also do not have to be sharp limits. Instead, values that go slightly beyond or below these values should also be considered to lie within the scope of the invention.

In terms of terminology, it should be explained, with regard to the “mass stream,” that it should correspond to the variable that is usually referred to with the parameter \dot{m} in calculation and design. In the development of the extruders used in the state of the art, as described initially, designs having parameter ratios that essentially result in a straight line when plotting the throughput on the ordinate and the active length of the extruder on the abscissa in a Cartesian coordinate system have been proposed. However, this straight line does not run through the zero point of the coordinate system. Also, when a throughput of starting from 200 kg/h is aimed at, for example, it requires an extruder length of about 1,500 mm and up. In contrast, clearly shorter extruders can be produced with the value range proposed here, at the same required throughput of 200 kg/h, for example extruders having a length of only about 200 mm to 800 mm, at diameters D of about 400 mm or approximately 100 mm.

According to a fifth aspect of the invention proposed here, the set task is accomplished by a method for plastification of a starting material in the form of plastic, particularly of plastic granulate, by means of a single-screw plastification machine as described above, wherein the controller preferably operates the screw at a circumferential speed of less than 1.5 m/s, particularly less than 1.0 m/s. It is understood that this interval limit should also not be understood to be a sharp limit.

Depending on the polymer and the application case, the extruder works in a speed of rotation range and throughput range that is aimed at. The ratio of maximal throughput to minimal throughput usually lies between 5:1 and 20:1. Above the maximal throughput, a far-seeing engineer will plan a speed of rotation reserve of usually about 10% to 20%. The upper circumferential speed limit indicated as a design basis in the invention particularly relates to the maximal upper speed of rotation range aimed at, wherein it can also fundamentally be practical to process polymers that are sensitive to shear at lower circumferential speeds.

According to a sixth aspect of the present invention, the set task is accomplished by a set of a series, having two single-screw plastification machines as described above, wherein both have the same ratio between the mass stream \dot{m} and the active length L, with a deviation of maximally 10%.

For a clear understanding, in

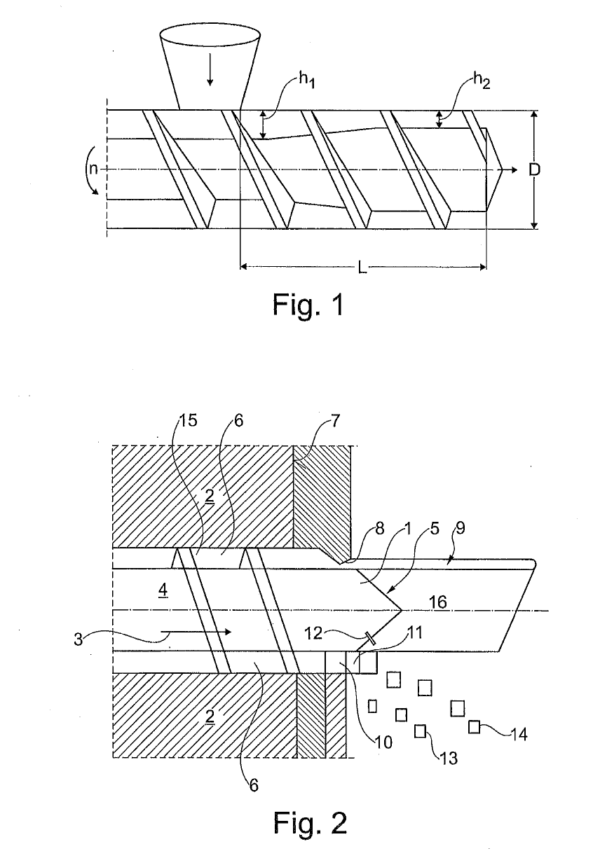

FIG. 1 in a schematic longitudinal section, an extruder having a filling funnel is shown, and in

FIG. 2 in a schematic longitudinal section, two tools that can be used alternatively and are different are shown as examples.

The screw in FIG. 1 has three zones within its active length L, at first having a channel depth h1, then a transition region, and finally having a channel depth h2, as well as having a screw diameter D and a speed of rotation n. The circumferential speed is calculated as the product of D, n and n.

The extrusion direction runs from left to right.

Parameter ranges currently favored for a squat screw of the invention presented here lie, above all, at

| | |
|---|---|
| speed of rotation | 0.05 to 1.0 m/s, |
| L/D | 1 to 8, |
| h/D | 1/20 to 1/150, |
| number of threads i | 2 to 20, and/or |
| diameter D | 150 to 800. |

At first glance, according to the previous state of development, the most practical screw diameter range begins at about 300 mm or less—wherein smaller values also appear to be practical, above all in the case of an extruder without a melt pump—and goes up to approximately 500 mm or more.

Ultimately, the throughput range known today can be transferred to an active screw length of less than 2,000 mm by means of a skilled selection of the screw diameter.

The screw 1 in FIG. 2 runs in a cylinder 2. It has a cylindrical part 4, at first, along its extrusion direction 3, and subsequently has a screw tip 5.

A thread 6 is formed between the screw 1 and the cylinder 2. The screw 1 conveys the melted, plasticized plastic in the extrusion direction 3 by means of the thread during operation.

The cylinder 2 ends even before the start of the screw tip 5. A tool is connected at its face 7, namely, for example (shown in the upper half of FIG. 2) a narrowing of the channel 6 to form an annular gap nozzle 8, so that during operation of the machine (not shown in its entirety), a tube 9 is extruded, or, for example (shown at the bottom of FIG. 2), a perforated plate 10 for extruding a plurality of melt strands 11 (shown as examples) and a subsequent blade 12, affixed to rotate along with the rotating screw 1 during operation, for cutting the melt strands 11 into granulate grains 13, 14 (numbered as examples) are provided.

The screw 1 projects out of a pressure region 15 upstream from the tool, through the tool, into a region 16 having ambient pressure. The tool forms the nozzle with the cylindrical part of the screw 1. The screw tip 5 lies completely in the pressure-reduced region, and part of the cross-sectional surface area of the screw 1 projects outward.

1. Single-screw plastification machine, above all single-screw extruder, suitable and set up for conveying, melting and homogenizing a starting material, above all a thermoplastic polymer, wherein the single-screw plastification machine has a screw having a screw diameter and an active length, and wherein the single-screw plastification machine is set up for rotating the screw, during operation, by means of a controller, at a circumferential speed,
wherein
the screw diameter D amounts to at least 150 mm, particularly 200 mm to 800 mm,
and wherein
the active length L has a ratio L/D to the screw diameter D of 1 to 8.

2. Single-screw plastification machine, above all single-screw extruder, suitable and set up for conveying, melting and homogenizing a starting material, above all a thermoplastic polymer, wherein the single-screw plastification machine has a screw having a screw diameter and an active length, and wherein the single-screw plastification machine is set up for rotating the screw, during operation, by means of a controller, at a circumferential speed,
wherein
the screw diameter D amounts to at least 150 mm, particularly 200 mm to 800 mm,
and wherein
the controller is set up for operating the screw at a circumferential speed of less than 1.5 m/s, preferably of less than 1.0 m/s, particularly preferably of between 0.05 m/s and 1.0 m/s.

3. Single-screw plastification machine, above all single-screw extruder, suitable and set up for conveying, melting and homogenizing a starting material, above all a thermoplastic polymer, wherein the single-screw plastification machine has a screw having a screw diameter and an active length, and wherein the single-screw plastification machine is set up for rotating the screw, during operation, by means of a controller, at a circumferential speed,
wherein
the active length L has a ratio L/D to the screw diameter D of 1 to 8,
and wherein
the controller is set up for operating the screw at a circumferential speed of less than 1.5 m/s, preferably of less than 1.0 m/s, particularly preferably of between 0.05 m/s and 1.0 m/s.

4. (canceled)

5. Single-screw plastification machine according to claim 1, wherein a melt pump is provided on the other side of the active length of the screw, in the machine direction, which pump is set up for producing a pressure buildup during operation.

6. Single-screw plastification machine
according to claim 1,
wherein
a pressure reducer is provided in the region of the active length L of the screw and/or in the region of a screw tip beyond the active length L, through which pressure reducer the screw extends with a part of its axial length into a region that is reduced in pressure during operation, particularly into a region having ambient pressure during operation.

7. Single-screw plastification machine according to claim 1, wherein an extrusion tool is connected beyond a cylinder of the screw, in the machine direction.

8. Single-screw plastification machine according to claim 6, wherein the extrusion tool has an annular gap nozzle.

9. Single-screw plastification machine according to claim 6, wherein the extrusion tool is set up for producing a ring-shaped extrudate during operation, particularly a tube.

10. Single-screw plastification machine
according to claim 1,
wherein
an extrusion tool is connected beyond a cylinder of the screw, in the machine direction, wherein the extrusion tool, during operation, is set up for producing a granulate, and has a perforated disk for producing a strand as well as a blade for cutting the strand up, wherein the blade is preferably disposed on the screw so as to rotate with it, particularly at the screw tip, or the blade is disposed in fixed manner, wherein the perforated disk can be disposed on the screw.

11. Single-screw plastification machine according to claim 1, wherein the active length L amounts to between 200 mm and 2,400 mm.

12. Single-screw plastification machine according to claim 1, wherein the screw diameter D has a ratio D/h to the channel depth h of 20 to 150.

13. Single-screw plastification machine according to claim 1, wherein the screw has multiple threads.

14. Single-screw plastification machine according to claim 1, wherein the screw has a modular connection device.

15. Single-screw plastification machine according to claim 1, wherein a cylinder enclosing the screw has an axially segmented structure.

16. Single-screw plastification machine according to claim 1, wherein the screw has a temperature-regulating means.

17. Single-screw plastification machine according to claim 1, wherein the screw has a screw shaft having a recess, which has a thrust bearing or is set up for accommodating a thrust bearing.

18. Single-screw plastification machine according to claim 1, wherein the screw has a screw shaft that is structured as a screw mandrel.

19. Single-screw plastification machine according to claim 1, wherein the machine is a plastics injection-molding machine.

20. Single-screw plastification machine according to claim 19, further comprising a central injection piston.

21. Single-screw plastification machine for conveying, melting and homogenizing starting material, above all a single-screw extruder for a thermoplastic polymer, wherein the single-screw plastification machine has a screw having a screw diameter D and an active length L, and wherein the single-screw plastification machine is set up for rotating the screw, during operation, by means of a controller, at a circumferential speed, so that during operation, taking into consideration a number of threads, a throughput mass stream \dot{m} of the starting material occurs,
according to claim 1,
wherein
the active length L amounts to from 200 mm to 2,000 mm,
and wherein
during operation, the ratio between the mass stream \dot{m} and the active length L amounts to between 0.25 kg/h/mm and 1.4 kg/h/mm, particularly at least 0.5 kg/h/mm.

22. Method for plastification of a starting material, above all a thermoplastic polymer, by means of a single-screw plastification machine according to claim 1, particularly in the form of a single-screw extruder, wherein the controller operates the screw preferably at a circumferential speed of less than 1.5 m/s, particularly of less than 1.0 m/s.

23. Set of a series, having two single-screw plastification machines according to claim 1, wherein both have the same ratio between the mass stream \dot{m} and the active length L, with a deviation of maximally 10%.
